(19) United States
(12) Patent Application Publication
(10) Pub. No.: US 2002/0074070 A1
(43) Pub. Date: Jun. 20, 2002

(54) Combination of a tire and a wheel rim

(76) Inventor: Yu-Ren Liu, Chang-Hua Hsien (TW)

Correspondence Address: CHARLES E. BAXLEY, ESQUIRE, 5th FLOOR, 59 JOHN STREET, NEW YORK, NY, 10038, US

(21) Appl. No.: 09/735,868

(22) Filed: Dec. 14, 2000

(51) Int. Cl. B60C 29/06

(52) U.S. Cl. 152/427

(57) ABSTRACT

A tire is engaged with a wheel rim and a hole is defined through the wheel rim. A flexible valve is inserted in the hole and a passage is defined through the flexible valve. The passage is sealed by pressure when the tire is inflated.

### FIELD OF THE INVENTION

The present invention relates to a tire structure having a rubber valve extending through the wheel rim and a passage in the valve can be sealed by the pressure form the sidewall of the tire.

### BACKGROUND OF THE INVENTION

A conventional tire for scooters or strollers is shown in FIG. 5 and generally includes a solid tire engaged with a wheel rim 11. The solid tire is generally made from EVA or PU. Although PU has better flexibility and is easily steered, the material tends to be deformed permanently and therefore is disengaged from the ring 11. It is too stiff for the EVA and tends to be worn out so that the EVA tire cannot be satisfied by the customers. If the tire is made from rubber which is too heavy. Therefore, the small tires used on scooters or strollers need inflatable tires. The conventional inflatable tires involve more parts and are expensive which is the last factor that the tires need.

The present invention intends to provide an inflatable tire structure that has a flexible valve extending through the wheel rim and the valve is sealed by the pressure of the sidewall.

### SUMMARY OF THE INVENTION

In accordance with one aspect of the present invention, there is provided a combination of a tire and a wheel rim. The tire is engaged with the wheel rim and a hole is defined through the wheel rim. A flexible valve is inserted in the hole and a passage is defined through the flexible valve. The passage is sealed by pressure when the tire is inflated.

The primary object of the present invention is to provide a flexible valve engaged with the wheel rim and the flexible valve can be squeezed by the sidewall of the tire and the pressure of the tire to seal the passage in the valve.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is a cross sectional view to show a combination of a tire and a wheel rim of the present invention;

FIG. 2 is a cross sectional view to show an inflation needle inserted in the passage of the flexible valve as shown in FIG. 1;

FIG. 3 is a cross sectional view to show another embodiment of the flexible valve of the present invention;

FIG. 4 is a cross sectional view to show yet another embodiment of the wheel rim of the present invention, and

FIG. 5 is a perspective view to show a conventional solid tire.

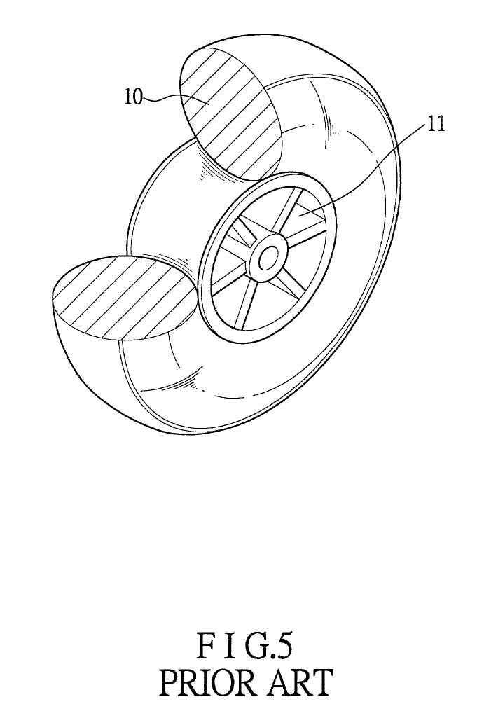

### DETAILED DESCRIPTION OF THE PREFERRED EMBODIMENTS

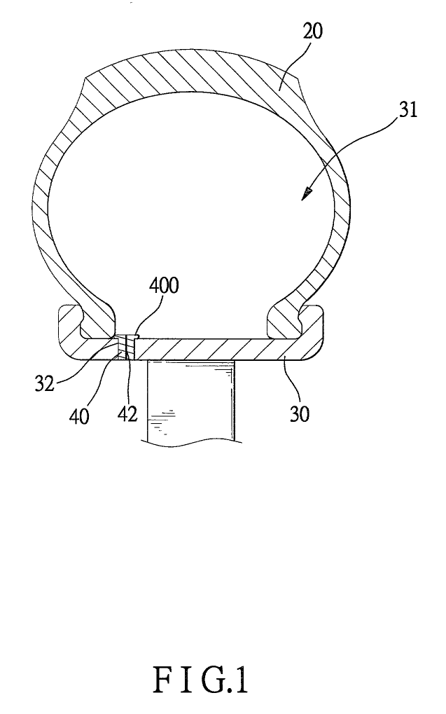

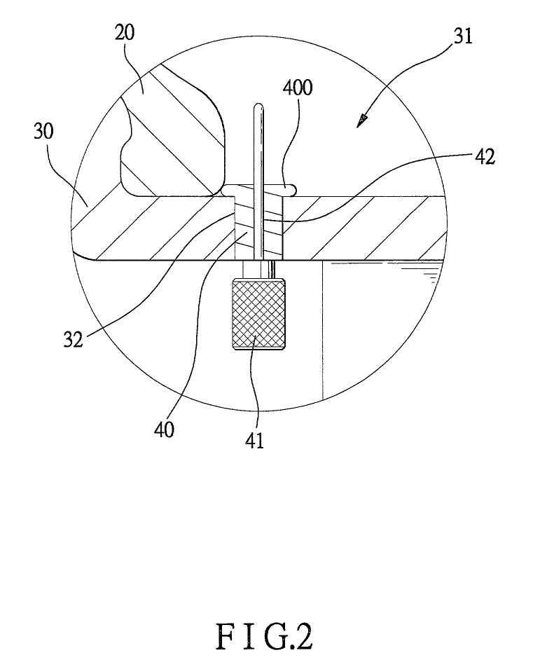

Referring to FIGS. 1 and 2, the combination of a tire 20 and a wheel rim 30 of the present invention includes a hole 32 defined through the wheel rim 30 to which the tire 20 is engaged. A flexible valve 40 is inserted in the hole 32 and a passage 42 is defined through the flexible valve 40. Therefore, an inflation needle 41 can be inserted into the passage 42 so as to inflate the tire 20. The passage 42 cam be sealed by pressure form the interior 31 of the tire 20 and the sidewall of the tire 20. A flange 400 extends radially outward from the flexible valve 40 and is engaged with an inner periphery of the wheel rim 30.

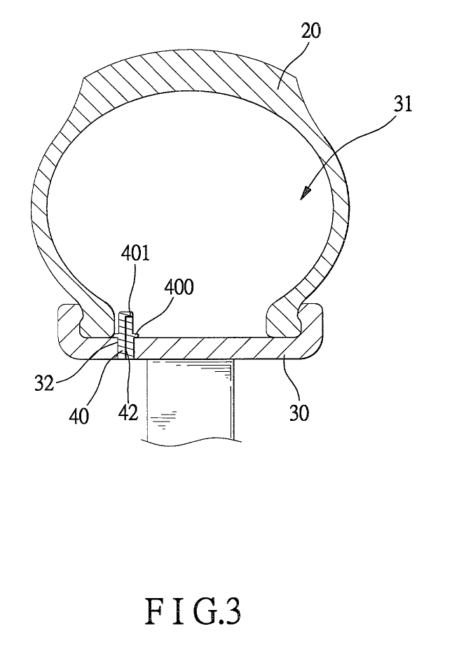

FIG. 3 shows another embodiment of the flexible valve 40 wherein an extension portion 401 extends from the flange 400 and another passage is defined radially in the extension portion 401 of the flexible valve 40 and communicates with the passage 42.

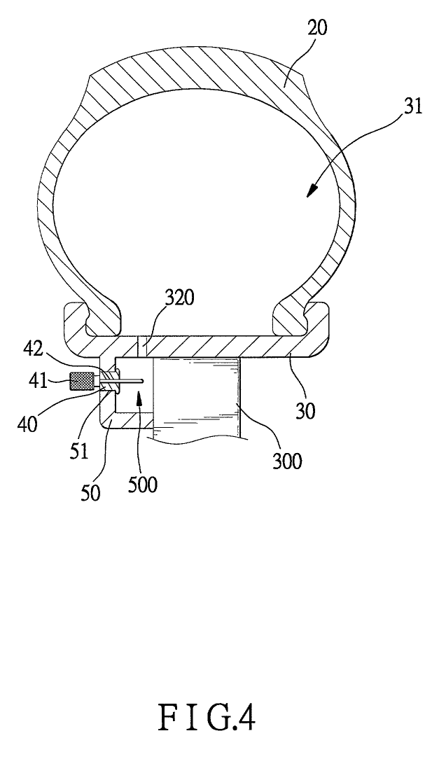

FIG. 4 shows another embodiment of the wheel rim 30 wherein an extension wall 50 extends from an outer periphery of the wheel rim 30 and a chamber 500 is defined by the extension wall 50 and a rib 300 in an inner periphery of the wheel rim 30. The extension wall 50 has a hole 51 for receiving the flexible valve 40 therein and a passage 320 defined through the wheel rim 30. The chamber 500 communicates with an interior 31 of the tire 20 via the passage 320. The flexible valve 40 can be easily made from rubber and is securely engaged with the wheel rim 30 by its flexible mature. The flexible valve 40 is suitable for small wheels such as 5 or 6 inches wheel.

While we have shown and described various embodiments in accordance with the present invention, it should be clear to those skilled in the art that further embodiments may be made without departing from the scope and spirit of the present invention.

What is claimed is:

1. A combination of a tire and a wheel rim, comprising:
a flexible valve engaged with said wheel rim to which said tire is engaged, a passage defined through said flexible valve and said passage being sealed by pressure.

2. The tire structure as claimed in claim 1 further comprising a flange extending radially outward from said flexible valve and engaged with an inner periphery of said wheel rim.

3. The tire structure as claimed in claim 1 further comprising an extension wall extending from an outer periphery of said wheel rim and a chamber defined by said extension wall and a rib in an inner periphery of said wheel rim, said extension Pall having a hole for receiving said flexible valve therein and a passage defined through said wheel rim, said chamber communicating with an interior of said tire via said passage.
